(19) United States
(12) Patent Application Publication
(10) Pub. No.: US 2013/0060447 A1
(43) Pub. Date: Mar. 7, 2013

(54) VEHICLE DIAGNOSIS DEVICE AND METHOD

(71) Applicants: Noureddine Guerrassi, Vineuil (FR); Pierre Allezy, Messancy (BE)

(72) Inventors: Noureddine Guerrassi, Vineuil (FR); Pierre Allezy, Messancy (BE)

(73) Assignee: DELPHI TECHNOLOGIES HOLDING, S.ARL, BASCHARAGE, LU (LU)

(21) Appl. No.: 13/639,216

(22) PCT Filed: Apr. 8, 2011
(86) PCT No.: PCT/EP11/55506

§ 371 Date: Oct. 4, 2012

(30) Foreign Application Priority Data
Apr. 8, 2010 (EP) 10159322.6

(51) Int. Cl. G01M 15/08; F02D 28/00; G06F 19/00

(52) U.S. Cl. 701/102; 702/35

(57) ABSTRACT

A method of diagnosing faults within an engine system, the engine system comprising a plurality of cylinders, the method comprising: monitoring the output signal of one or more in-cylinder pressure sensors within the engine system, each of the one or more in-cylinder pressure sensors being associated with a cylinder within the engine system; determining a pressure related parameter for a given cylinder having an associated in-cylinder pressure sensor; and diagnosing the presence of faults within the engine system on the basis of the pressure related parameter.

### CROSS REFERENCE TO RELATED APPLICATIONS

This application is a national stage application under 35 U.S.C. 371 of PCT Application No. PCT/EP2011/055506 having an international filing date of 8 Apr. 2011, which designated the United States, which PCT application claimed the benefit of European Patent Application No. 10159322.6 filed 8 Apr. 2010, the entire disclosure of each of which are hereby incorporated herein by reference.

### FIELD OF THE INVENTION

This invention relates to a vehicle diagnosis device and method. In particular, the present invention relates to a diagnosis unit for diagnosing faults in a fuel delivery system of a vehicle that cause variations in exhaust emission levels. The invention extends to a method of diagnosing faults in the fuel delivery system and to a method of calibrating such a device/method.

### BACKGROUND OF THE INVENTION

With the introduction of stricter emission regulations (particularly in the USA), on-board diagnostic (OBD) requirements have emerged aimed at indicating faults causing excessive vehicle emission levels (emission threshold based diagnosis). These requirements include identification of the source of the fault for a quick and guided repair of the problem.

One of the systems requiring fault indication is the vehicle's fuel delivery system. Regulations require diagnosis of fuel injection quantity, pressure and timing fault types which may cause either an increase/decrease in the quality/quantity of combustion and thus a variation in the emission levels. It is noted that any fault diagnosis system/method needs to work reliably across the full range of operation of a vehicle's engine (speed and load) and be robust to variations in ambient conditions, driving conditions and style and fuel quality.

Variations in the fuel injection quantity, cylinder pressure and injection timing (of which misfire is an extreme case) cause a change in the rotational speed of the engine crankshaft. Current crank (shaft) speed misfire diagnostic methods exploit this by comparing the average engine speed over one cylinder to the next. These methods vary in the number of crank teeth over which the average engine speed is calculated, but the principle remains the same in that the diagnosis is made by detecting when the misfiring of a cylinder causes a deceleration in its rotational speed relative to the adjacent cylinder(s) (Note: adjacent in this context means adjacent in the firing order and not necessarily physically adjacent).

Accelerometers (referred to as “knock” sensors) have also been widely used for cylinder misfire detection, with the knock sensor output being fed back to the engine control unit which then compensates for the misfire by adjusting operation of the other cylinders.

Diagnosis techniques such as those described above typically rely on the use of a number of different sensor devices, some of which may be bespoke to the particular diagnosis method.

It is an object of the present invention to provide a diagnostic system or method which allows reliable diagnosis or identification of fault conditions within an engine fuel system across the full range of operation of the vehicle's engine. It is a further object of the present invention to provide a diagnosis method that can diagnose a range of vehicle faults such as compression ratio errors, blow by errors, engine misfire and over-fuelling conditions. It is a yet further object of the present invention to provide a diagnosis method that can self-diagnose faults within the sensor system, for example sensor drift.

### STATEMENTS OF INVENTION

According to a first aspect of the present invention there is provided a method of diagnosing faults within an engine system, the engine system comprising a plurality of cylinders, the method comprising: monitoring the output signal of one or more in-cylinder pressure sensors within the engine system, each of the one or more in-cylinder pressure sensors being associated with a cylinder within the engine system; determining a pressure related parameter for a given cylinder having an associated in-cylinder pressure sensor; and diagnosing the presence of faults within the engine system on the basis of the pressure related parameter.

The present invention recognises that faults within the engine system may be determined by monitoring the pressure signals received from in-cylinder pressure sensors. Various pressure related parameters such as the pressure within the cylinder, the Indicated Mean Effective Pressure (IMEP) as calculated from the cylinder pressure or the Top Dead Centre position as calculated from the cylinder pressure may be determined and used to diagnose the presence of faults within the engine system (e.g. sensor drift, overfuelling, cylinder blow-by, cylinder mis-fire etc.).

Conveniently, the determining step may be performed when the engine system is in a motoring condition and the method may optionally further comprise waiting for a predetermined period of time after the engine system enters the motoring condition. This mitigates against “false” errors being diagnosed because of thermal conditions and intake pressure stabilization. As an alternative to waiting a predetermined period of time, the method may further comprise measuring the pressure and temperature within the engine cylinders until predefined testing conditions are satisfied.

In one variant of the present invention, the pressure related parameter may be the indicated mean effective pressure (IMEP) and the determining step may be performed when the engine system is in a motoring condition and the diagnosing step may be arranged to diagnose a sensor drift error if the IMEP value for the given cylinder is outside a predetermined range. In this example, the pressure related parameter is the indicated mean effective pressure (IMEP) and the diagnosing step comprises comparing determined IMEP values to IMEP values calculated from an engine model. Conveniently, the presence of sensor drift error detected by the above IMEP evaluation may optionally be verified by determining a top-dead-centre (TDC) offset value for the cylinder and tracking movements in this TDC offset value.

Conveniently, where the IMEP of a given cylinder is being monitored the diagnosing step may be arranged to diagnose an over-fuelling condition on the given cylinder if the difference between determined and calculated IMEP values is above a threshold value and if the determined IMEP value is greater than the calculated IMEP value. Furthermore, the diagnosing step may be arranged to diagnose a mis-fire condition on the given cylinder if the difference between determined and calculated IMEP values is above a threshold value and if the calculated IMEP value is greater than the determined IMEP value.

In a further variant of the present invention, the pressure related parameter determined in the determining step may be the top-dead-centre (TDC) position of the given cylinder and the diagnosing step may comprise comparing the determined TDC position with predicted TDC position to derive a TDC offset value for the cylinder within the engine system. If an offset is identified this may be used to offset timing demands within the injector associated with the cylinder for which an offset has been identified. Alternatively, the offset may be introduced into an engine control strategy.

Where a TDC offset has been identified the diagnosing step may be arranged to diagnose a cylinder blow by condition by comparing the difference between a TDC offset value and a previously derived/calculated TDC offset value. If the difference between the two TDC offset values varies by a first amount then a cylinder blow-by condition may be diagnosed.

For example, TDC offset may vary by −0.5 to +0.5 crank angle degrees. If the offset goes below −0.5 crank angle degrees then a blow-by or compression failure may be diagnosed (in other words if the TDC offset value moves in a negative crank angle direction and the absolute difference between TDC offset values exceeds a first threshold value then a blow-by or compression failure may be diagnosed).

Where a previously calculated/derived TDC offset has been identified, the diagnosing step may be arranged to diagnose a cylinder sensor drift condition if the difference between a further TDC offset value and the previously calculated/derived TDC offset value varies by a second amount. For example, if the offset goes above +0.5 crank angle degrees then a sensor failure may be diagnosed.

Conveniently, a sensor drift condition (identified from the above TDC offset value evaluation) may optionally be verified by determining the indicated mean effective pressure (IMEP) for the given cylinder and diagnosing a sensor drift error if the IMEP value for the given cylinder is outside a predetermined range.

In a further variant of the present invention, the pressure related parameter determined in the determining step may be the maximum cylinder pressure per engine cycle and the diagnosing step may be arranged to diagnose a compression ratio error condition for the given cylinder if the determined maximum cylinder pressure falls outside a range of values about a reference cylinder pressure. The reference cylinder pressures may be stored in a look-up table stored in or associated with the engine control unit. It is noted that the reference values depend on intake manifold absolute pressure.

Preferably, each cylinder within the engine system may be associated with an in-cylinder pressure sensor and the method may comprise monitoring the output signal of each in-cylinder pressure sensor within the engine system, determining a pressure related parameter for each cylinder; and diagnosing the presence of faults within the engine system on the basis of the determined pressure related parameter. Furthermore, the method may also comprise outputting an error signal on the basis of the output from the diagnosing step, e.g. for use in engine control.

According to a second aspect of the present invention, there is provided an ECU arranged to diagnose faults within an engine system, the engine system comprising a plurality of cylinders, the ECU comprising: monitoring means arranged to monitor the output signal of one or more in-cylinder pressure sensors within the engine system, each of the one or more in-cylinder pressure sensors being associated with a cylinder within the engine system; processing means arranged to determine a pressure related parameter for a given cylinder having an associated in-cylinder pressure sensor and arranged to diagnose the presence of faults within the engine system on the basis of the pressure related parameter.

The invention extends to a computer readable medium comprising a computer program arranged to configure a computer or an electronic control unit to implement the method according to the first aspect of the present invention.

The invention also extends to a method of controlling an engine system comprising outputting a TDC offset value as determined in the first aspect of the invention to an engine model for use in engine control.

It is noted that preferred features of the first aspect of the present invention may also apply to the second aspect of the present invention.

### BRIEF DESCRIPTION OF THE DRAWINGS

In order that the invention may be more readily understood, reference will now be made, by way of example, to the accompanying drawings in which:

FIG. 1 shows a representation of an engine system;

FIG. 2 shows observed sensor drift for an engine at cold idle;

FIG. 3 shows observed sensor drift for an engine in a foot off driving condition;

FIG. 4 is a flow chart showing a foot-off diagnosis method in accordance with an embodiment of the present invention;

FIG. 5 is a plot of IMEP versus air mass flow showing the detection of a faulty pressure sensor;

FIG. 6 a flow chart showing a further diagnosis method in accordance with an embodiment of the present invention;

FIG. 7 is a plot of IMEP versus time showing the effects of a misfiring cylinder;

FIGS. 8 and 9 are general representations of an engine control unit suitable for use with the present invention and a flow chart representing the basic method according to the present invention;

FIG. 10 shows pressure signal traces and TDC offset values for a faulty sensor and for a cylinder blow-by condition.

### DETAILED DESCRIPTION

In the following description and associated drawings like numerals are used to denote like features.

The following terms may also be referenced in the following description and associated drawings: IMEP—Indicated Mean Effective Pressure, used in this development for engine torque control (Bar) (Indicated engine torque=IMEP×Engine swept volume (constant)); CA50%—Crank angle position at 50% of cumulative heat release rate (here referred to as the Centre of Combustion Position) (Degree Crank Angle); V—Cylinder volume (variable) (cm³); Q—Fuel mass or generated combustion heat; TDC—Top Dead Centre (Reference 0 Crank angle); ECU Electronic Control unit.

In a compression-ignition internal combustion engine, such as a diesel engine, combustion takes place within one or more combustion chambers or cylinders, each chamber being defined partly by a reciprocating piston and partly by the walls of a cylinder bore formed in a cylinder head. The piston slides within the cylinder so that, when the engine is running, the volume of the combustion chamber cyclically increases and decreases. When the combustion chamber is at its minimum volume, the piston is said to be at ‘Top Dead Centre’ (TDC), and when the combustion chamber is at its maximum volume, the piston is said to be at ‘Bottom Dead Centre’ (BDC).

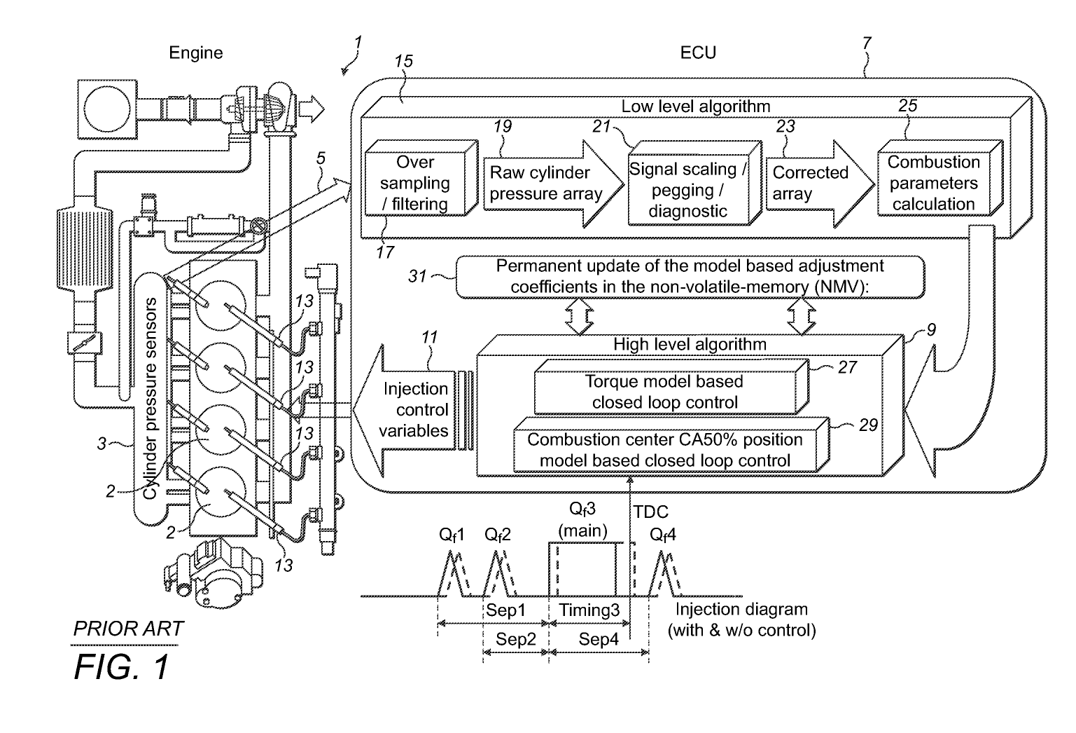

FIG. 1 shows a representation of an engine system 1 described in the Applicant's co-pending European patent application 08168714.7. The engine system 1 comprises a plurality of cylinders 2. In-cylinder pressure measurements from cylinder pressure sensors 3 are fed (arrow 5) into the vehicle's engine control unit 7. The control method in accordance with the system described in the figure is generally represented by the “high level” algorithm box 9, the output of which are injection control variables 11 which are sent to the engine's injectors 13.

Prior to the sensor output 5 being used by the high level algorithm 9, a “low level” algorithm 15 cleans up the sensor data and calculates a number of combustion parameters which are then used by the high level algorithm 9.

In order to reduce the calculation load on the ECU and to enable the engine model 9 to calculate injection control variables sufficiently quickly at all engine speeds the in-cylinder pressure measurements may conveniently be over-sampled.

Within the low level algorithm 15 therefore the oversampled output of the sensors 3 is filtered by a filtering module 17 to produce a raw cylinder pressure array 19. The raw array 19 may then be passed to a scaling and diagnostic module 21 which performs pressure measurement pegging and other scaling functions in order to output a corrected pressure array 23. It is noted that the applicant's patent application EP1936157 describes a pressure pegging method that may be utilised here.

The corrected pressure array 23 is then sent to a combustion parameters calculation module 25 which calculates a number of combustion parameters as described below which may then be used by an engine model to control engine operation.

Parameters calculated in the module 25 may comprise: the indicated mean effective pressure (IMEP) in bar (it is noted that the indicated engine torque=IMEP engine×swept volume (a constant)); CA50%, the cumulative heat release rate (HRR); peak pressure and location of peak pressure; the pressure derivative with respect to crank angle, DP/Da, for combustion noise calculations (in particular the max DP/Da and location of this maximum may be calculated).

The control method in accordance with the disclosure of EP Application 08168714.7 is, as noted above, generally represented by the “high level” algorithm box 9. The control method provides a mechanism for determining fuel quantities via a torque model 27 and for determining injection timings via a combustion centre position model 29. Both models predict injection parameters with reference to one or more mathematical functions (as described below). In order to maintain the accuracy of the various engine models 27, 29 the model coefficients are adjusted with reference to actual measured engine parameters. The adjusted model coefficients are permanently stored within the non-volatile memory 31 of the ECU 7.

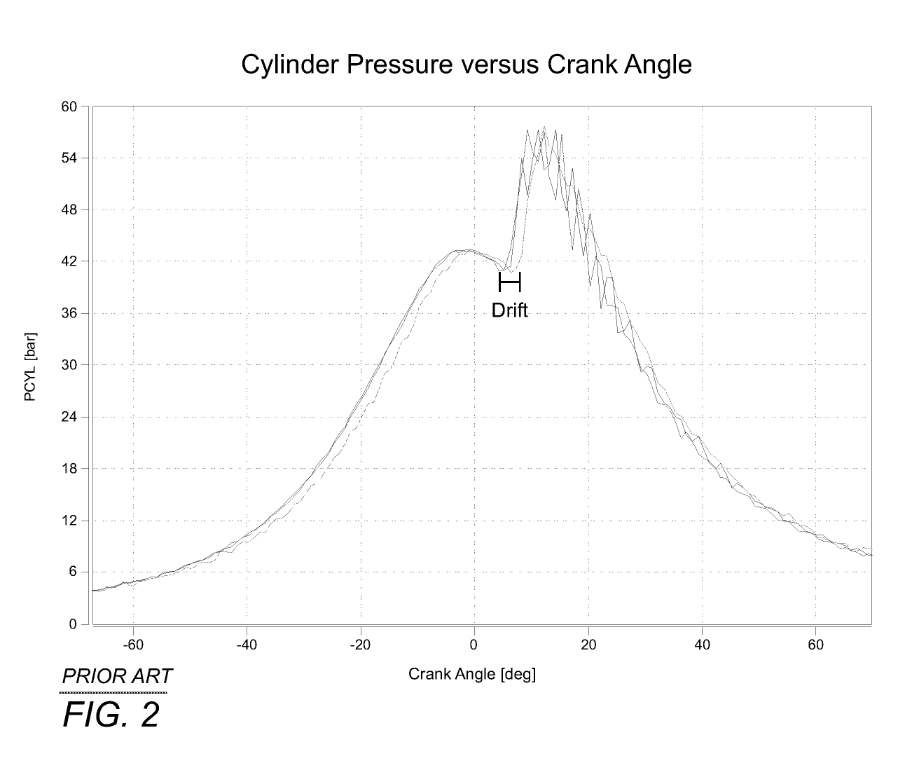

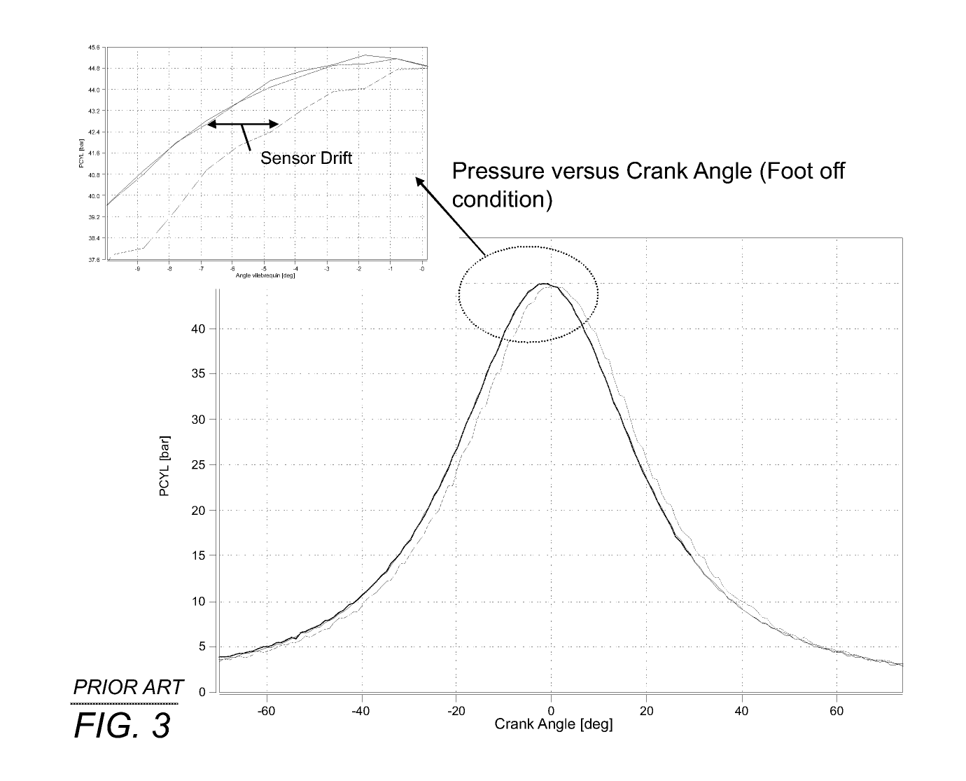

FIGS. 2 and 3 illustrate the problem of sensor drift that is observed on cylinder pressure sensors after periods of in service use. FIG. 2 shows a number of traces of cylinder pressure versus crank angle for an engine system in a cold idle state. It can be seen that the various pressure curves do not line up and this represents a drift in the sensor readings that develops after long periods of use.

FIG. 3 shows a similar trace for an engine system that is in a foot-off condition (i.e. a motoring condition). A portion of the figure has been enlarged and it can be seen that the sensor drift corresponds to an offset of a couple of degrees of crank angle at certain points on the pressure curve.

It is noted that the results shown in FIGS. 2 and 3 were derived from a test engine after durability testing. The same drift in the sensor output would also be experienced by in-service engines over time.

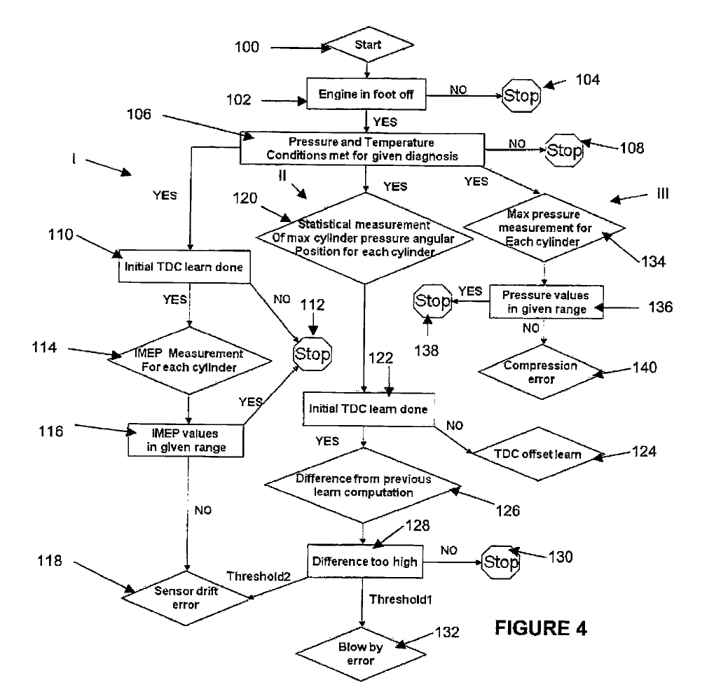

FIG. 4 is a flow chart showing a diagnosis algorithm in accordance with an embodiment of the present invention for use when an engine system is motoring (i.e. a “foot off” condition).

In Step 100 the vehicle ECU initiates the diagnosis algorithm. This initiation could be in response to a driver or maintenance command or alternatively the algorithm could be run periodically.

In Step 102, the ECU performs a check to see if the engine is in a foot-off condition (in other words that the engine is motoring and no fuel is being supplied to the injectors). If the engine is not motoring then the process stops in Step 104.

In Step 106 the ECU checks to make sure that pressure and temperature conditions within the engine are suitable to run the diagnosis algorithm. This step essentially checks that the engine has been in a foot off condition for long enough to allow the diagnosis to run. If the pressure/temperature conditions are not met then the process stops in Step 108.

If the pressure/temperature conditions are met then the ECU may run one of three basic sub-processes, I, I or III. Process/is designed to diagnose sensor drift errors. Process II can either diagnose sensor drift or blow-by errors. Process III can diagnose compression errors within the cylinders of the engine.

In process I, the ECU first checks in Step 110 whether the output of the pressure sensors has been used to determine the true top dead centre position of the engine cylinders. If a “TDC learn” has not been performed then the process stops in Step 112.

If the TDC position of each cylinder is known then the process moves to step 114 in which the IMEP value for each cylinder is calculated from the pressure sensors. The IMEP value may be calculated by taking pressure values in the interval from 180° of crank angle before TDC to 180° of crank angle after TDC (i.e. the compression and power strokes). IMEP may then be calculated in accordance with the following equation:

$${IMEP}_{hp} = \frac{1}{V} {\int }_{- 180 CAD}^{180 CAD} P d V$$

where CAD=crank angle degree, V is the volume within the cylinder, P is the measured pressure value and IMEPₕₚ is the indicated mean effective pressure of the high pressure cycle (i.e. compression to power stroke).

In Step 116, the ECU determines if the calculated IMEP for each cylinder is within a pre-defined range. If all cylinders are within standard operating ranges then the process stops in Step 112.

If one or more cylinders shows an IMEP reading the is outside of the given range then the process returns a sensor drift error in Step 118.

In process II, the ECU initially undertakes, in Step 120, a measurement of the maximum cylinder pressure with respect to angular position for each cylinder. This is a statistical measurement performed over a number of engine cycles. This step determines the effective top dead centre position of each cylinder.

In Step 122, the ECU checks to see if the measured TDC position in Step 120 has been compared to the expected TDC position for each cylinder (it is noted that the expected TDC position may be pre-loaded and stored on the ECU). If the offset from the expected TDC position has not yet been determined then, in Step 124, the ECU determines the offset between the measured and expected values. It is noted that due to heat losses the maximum pressure in a cylinder of a motoring engine is approximately 1 crank angle degree before the geometric top dead centre of the cylinder. The offset that is calculated by the ECU is therefore with respect to the thermodynamic TDC position (1° crank angle before geometric TDC).

If an initial offset between the measured and expected TDC positions has been calculated then the diagnosis process moves to Step 126 in which the difference from the previous offset calculation is determined for each cylinder.

In Step 128, the variation in the offset is assessed for each cylinder. If the variation is within pre-defined limits then the diagnosis process ends in Step 130.

If the offset variation for any cylinder is below a first threshold/“varies by a first amount” (e.g. if the TDC offset drops below 0.5 crank angle degrees from the initial learn TDC offset) then the ECU may determine that there is a blow-by error in the cylinder under evaluation (Step 132). If the offset variation is above the second threshold/“varies by a second amount” (e.g. if the TDC offset rises above 0.5 crank angle degrees from the initial learn TDC offset) then a sensor drift error is output (Step 118) for that cylinder.

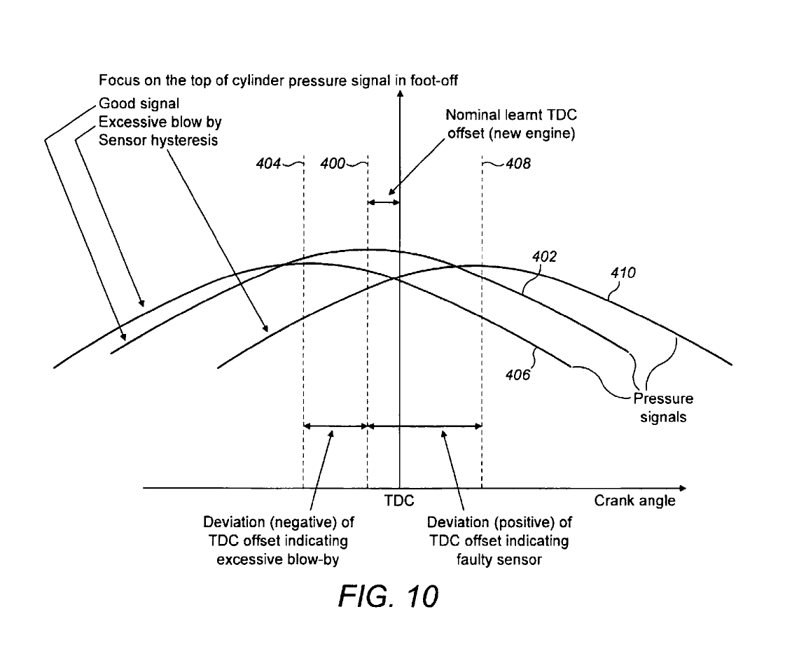

The determination of a sensor drift error or a blow-by error is also shown in FIG. 10. The vertical axis in FIG. 10 represents the expected TDC position. The initial offset between the expected and measured TDC positions is shown at 400. An engine system operating within normal parameters produces the pressure signal 402 which has its maximum at the initial offset position.

The TDC offset may be periodically re-calculated. If the TDC offset moves in a negative crank angle direction relative to the initial TDC offset position (to position 404) then this indicates a cylinder blow-by condition. The corresponding pressure signal trace for this condition is shown at trace 406.

If the TDC offset moves in a positive crank angle direction relative to the initial TDC offset position (to position 408) then this indicates a cylinder sensor drift condition. The corresponding pressure signal trace for this condition is shown at trace 410.

In process III the ECU initially, in Step 134, determines the maximum pressure measurement for each cylinder and in Step 136 determines if the pressure values are within a pre-determined range. If the values are in range then the diagnosis process stops in Step 138. If the pressure value on any cylinder is outside of the pre-determined range then the diagnosis process returns a compression ratio error for the cylinder in question (Step 140).

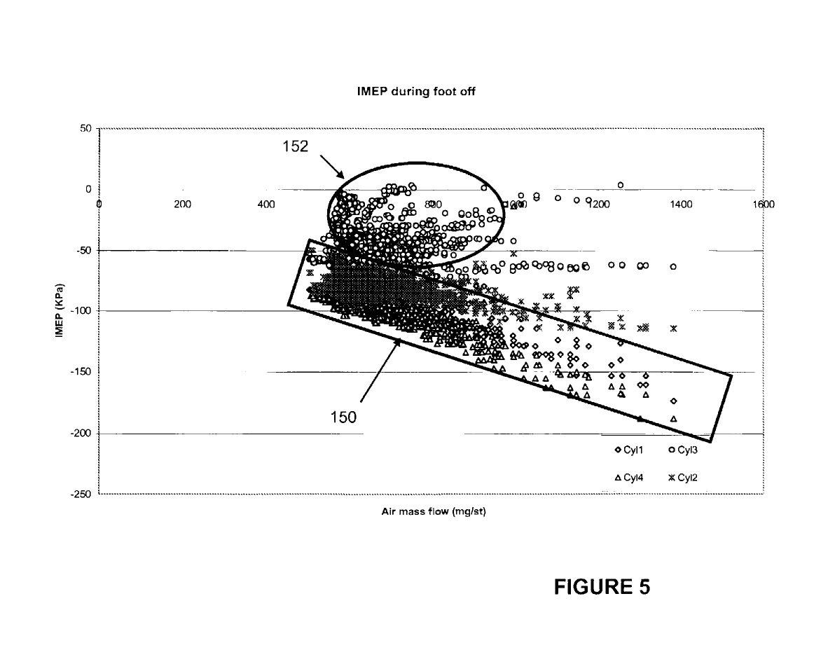

FIG. 5 shows an example of cylinder pressure sensor drift that may be detected by the diagnosis method according to an embodiment of the present invention. The figure illustrates the results of the analysis of computed IMEP versus air mass flow in foot off driving conditions with coolant temperature in the range 0-80° C. It can be seen that three of the four cylinder sensors return IMEP readings within the valid, boxed region 150. The sensor on cylinder 3 however is defective due to a wrongly measured IMEP (see circled area 152).

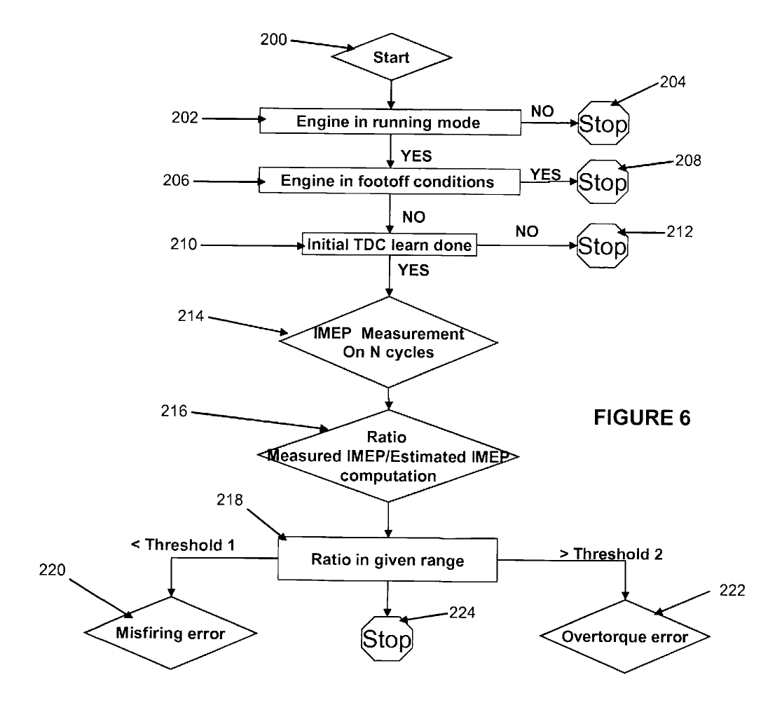

FIG. 6 illustrates the diagnosis process that may be performed during normal operating conditions (i.e. when the injectors are receiving and injecting fuel into the engine).

In Step 200 the diagnosis process is started and in Step 202 the ECU checks that the engine is in a running mode. If no then the diagnostic process ends in Step 104. The ECU then checks, in Step 106, whether the vehicle is in a motoring (foot off condition). If the engine is motoring then the process terminates in Step 108. Finally, the ECU checks, in Step 110, whether the top dead centre position has been determined. If TDC has not been determined then the process terminates in Step 112.

In Step 214, the pressure signals from the pressure sensors in each cylinder are used to measure the IMEP within each cylinder over time, i.e. over N cycles. In Step 216 a ratio of measured to estimated IMEP is calculated. It is therefore noted that in Step 216 an estimated IMEP value based on the current engine operating conditions is either calculated or received by the ECU 7. It is noted that the Applicant's co-pending European patent application 08168714.7 relates to an engine control model in which parameters such as the IMEP for each cylinder are calculated.

In Step 218 the ECU checks whether the ratio of measured to estimated IMEP is within a given range. If the ratio is less than a first threshold value (Step 220) then a misfiring fault is returned for the cylinder in question. If the ratio is determined to exceed a second threshold (Step 222) then an over fuelling fault is returned for the cylinder in question. If the ratio is within the predetermined allowable range then the diagnosis process terminates in Step 224.

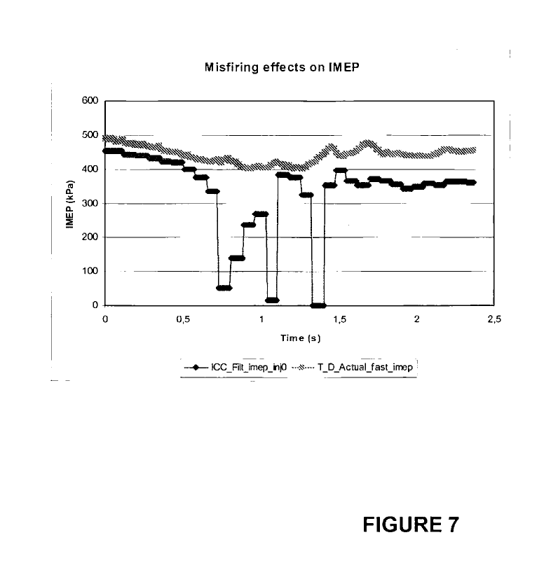

FIG. 7 represents a misfiring error on a cylinder (IMEP variations in the bottom trace denote the effects of a misfire).

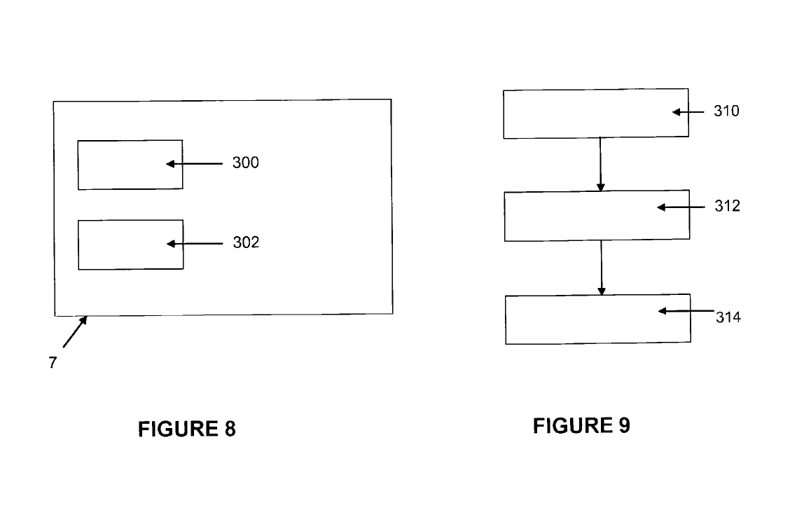

FIGS. 8 and 9 are general representations of an engine control unit suitable for use with the present invention and a flow chart representing the basic method according to the present invention.

In FIG. 8 an ECU 7 comprises monitoring means 300 and processing means 302. In FIG. 9, the method according to an embodiment of the present invention comprises monitoring 310 the output of in-cylinder pressure sensors, determining 312 a pressure related parameter and diagnosing 314 faults within the engine system.

It will be understood that the embodiments described above are given by way of example only and are not intended to limit the invention, the scope of which is defined in the appended claims. It will also be understood that the embodiments described may be used individually or in combination.

1. A method of diagnosing faults within an engine system, the engine system comprising a plurality of cylinders, the method comprising:
monitoring the output signal of one or more in-cylinder pressure sensors within the engine system, each of the one or more in-cylinder pressure sensors being associated with a cylinder within the engine system;
determining a pressure related parameter for a given cylinder having an associated in-cylinder pressure sensor; and
diagnosing the presence of faults within the engine system on the basis of the pressure related parameter.

2. A method as claimed in claim 1, wherein the determining step is performed when the engine system is in a motoring condition and the method further comprises waiting for a predetermined period of time after the engine system enters the motoring condition.

3. A method as claimed in claim 1, further comprising measuring the pressure and temperature within the engine cylinders until predefined testing conditions are satisfied.

4. A method as claimed in claim 1, wherein the pressure related parameter is the indicated mean effective pressure (IMEP) and wherein the determining step is performed when the engine system is in a motoring condition and the diagnosing step is arranged to diagnose a sensor drift error if the IMEP value for the given cylinder is outside a predetermined range.

5. A method as claimed in claim 4, comprising verifying the presence of the sensor drift error diagnosed from the IMEP value by:
a) determining the top-dead-centre (TDC) position of the given cylinder;
b) comparing the determined TDC position with predicted TDC position to derive an initial TDC offset value for the cylinder within the engine system;
c) deriving a further TDC offset value and diagnosing a cylinder sensor drift condition if the further TDC offset value varies from the initial TDC offset value by a predetermined amount.

6. A method as claimed in claim 1, wherein the pressure related parameter is the indicated mean effective pressure (IMEP) and wherein the diagnosing step comprises comparing determined IMEP values to IMEP values calculated from an engine model.

7. A method as claimed in claim 6, wherein the diagnosing step is arranged to diagnose an over-fuelling condition on the given cylinder if the difference between determined and calculated IMEP values is above a threshold value and if the determined IMEP value is greater than the calculated IMEP value.

8. A method as claimed in claim 6, wherein the diagnosing step is arranged to diagnose a mis-fire condition on the given cylinder if the difference between determined and calculated IMEP values is above a threshold value and if the calculated IMEP value is greater than the determined IMEP value.

9. A method as claimed in claim 1, wherein the pressure related parameter determined in the determining step is the top-dead-centre (TDC) position of the given cylinder and the diagnosing step comprises comparing the determined TDC position with predicted TDC position to derive a TDC offset value for the cylinder within the engine system.

10. A method as claimed in claim 9, further comprising deriving a further TDC offset value and wherein the diagnosing step is arranged to diagnose a cylinder blow by condition if the further TDC offset value varies from a previously derived TDC offset value by a first amount.

11. A method as claimed in claim 9, further comprising deriving a further TDC offset value and wherein the diagnosing step is arranged to diagnose a cylinder sensor drift condition if the further TDC offset value varies from a previously derived TDC offset value by a second amount.

12. A method as claimed in claim 11, further comprising verifying the presence of the cylinder sensor drift condition diagnosed from the TDC offset value variation by determining, when the engine system is in a motoring condition, the indicated mean effective pressure (IMEP) for the given cylinder and diagnosing a sensor drift error if the IMEP value for the given cylinder is outside a predetermined range.

13. A method as claimed in claim 1, wherein the pressure related parameter determined in the determining step is the maximum cylinder pressure per engine cycle and the diagnosing step is arranged to diagnose a compression ratio error condition for the given cylinder if the determined maximum cylinder pressure falls outside a range of values about a reference cylinder pressure.

14. A method as claimed claim 1 wherein each cylinder within the engine system is associated with an in-cylinder pressure sensor and the method comprises monitoring the output signal of each in-cylinder pressure sensor within the engine system, determining a pressure related parameter for each cylinder; and
diagnosing the presence of faults within the engine system on the basis of the determined pressure related parameter, the method optionally further comprising outputting an error signal on the basis of the output from the diagnosing step.

15. An ECU arranged to diagnose faults within an engine system, the engine system comprising a plurality of cylinders, the ECU comprising:
monitoring arrangement arranged to monitor the output signal of one or more in-cylinder pressure sensors within the engine system, each of the one or more in-cylinder pressure sensors being associated with a cylinder within the engine system;
processing arrangement arranged to determine a pressure related parameter for a given cylinder having an associated in-cylinder pressure sensor and arranged to diagnose the presence of faults within the engine system on the basis of the pressure related parameter.

16. A computer readable medium comprising a computer program arranged to configure a computer or an electronic control unit to implement the method according to claim 1.

17. A method of controlling an engine system comprising outputting the TDC offset value of claim 9 to an engine model for use in engine control.

18. A method as claimed in claim 6, wherein the diagnosing step is arranged to diagnose an over-fuelling condition on the given cylinder if a determined-to-estimated IMEP ratio is greater than an over-fuelling threshold value.

19. A method as claimed in claim 18, further comprising diagnosing faults when the engine system is in a running mode and is not in a motoring condition and wherein the determined IMEP value is measured over a plurality of engine cycles.

20. A method as claimed in claim 11, wherein the presence of the cylinder sensor drift condition diagnosed from the TDC offset variation is used to verify a cylinder sensor drift condition that has been identified by a method comprising:
monitoring the output signal of one or more in-cylinder pressure sensors within the engine system, each of the one or more in-cylinder pressure sensors being associated with a cylinder within the engine system;
determining, when the engine system is in a motoring condition, indicated mean effective pressure (IMEP) for a given cylinder having an associated in-cylinder pressure sensor; and
diagnosing the presence of cylinder sensor drift condition if the IMEP value for the given cylinder is outside of a predetermined range.
